(19) United States
(12) Patent Application Publication
(10) Pub. No.: US 2011/0058224 A1
(43) Pub. Date: Mar. 10, 2011

(54) COLOR PROCESSOR, IMAGE FORMING APPARATUS, COLOR PROCESSING METHOD AND COMPUTER READABLE MEDIUM

(75) Inventors: Takeshi Saito, Tokyo (JP); Haruka Saito, Fujisawa (JP); Masahiko Kubo, Kanagawa (JP); Kenji Hara, Kanagawa (JP); Toru Misaizu, Kanagawa (JP); Shigeru Arai, Kanagawa (JP); Kouta Matsuo, Kanagawa (JP)

(73) Assignee: FUJI XEROX CO., LTD., Tokyo (JP)

(21) Appl. No.: 12/724,504

(22) Filed: Mar. 16, 2010

(30) Foreign Application Priority Data
Sep. 9, 2009 (JP) 2009-207785

(51) Int. Cl. H04N 1/405

(52) U.S. Cl. 358/3.13

(57) ABSTRACT

A color processor includes: an acquisition unit that acquires first and second multi-valued color signals respectively indicating in a multi-valued manner quantities of first and second color materials used for reproducing color with a specific hue, the second color material having a different density from the first color material; a generation unit that generates first and second binary color signals by performing dither processing, respectively with first and second dither matrices, for the first and second multi-valued color signals acquired by the acquisition unit, the second dither matrix having the same angle and the same number of lines as the first dither matrix and being used for forming halftone dots at positions different from positions of halftone dots formed by use of the first dither matrix; and an output unit that outputs to a print mechanism the first and second binary color signals generated by the generation unit.

### CROSS REFERENCE TO RELATED APPLICATIONS

This application is based on and claims priority under 35 USC §119 from Japanese Patent Application No. 2009-207785 filed Sep. 9, 2009.

### BACKGROUND

1. Technical Field

The present invention relates to a color processor, an image forming apparatus, a color processing method and a computer readable medium.

2. Related Art

There is known a technique to prevent image defects due to screen moire and reduce costs when an image is recorded by use of light and dark toners.

### SUMMARY

According to an aspect of the present invention, there is provided a color processor including: an acquisition unit that acquires a first multi-valued color signal indicating in a multi-valued manner a quantity of a first color material used for reproducing color with a specific hue, and that acquires a second multi-valued color signal indicating in a multi-valued manner a quantity of a second color material used for reproducing color with the specific hue, the second color material having a different density from the first color material; a generation unit that generates a first binary color signal by performing dither processing, with a first dither matrix, for the first multi-valued color signal acquired by the acquisition unit, and that generates a second binary color signal by performing dither processing, with a second dither matrix, for the second multi-valued color signal acquired by the acquisition unit, the second dither matrix having the same angle and the same number of lines as the first dither matrix and being used for forming halftone dots at positions different from positions of halftone dots formed by use of the first dither matrix; and an output unit that outputs to a print mechanism the first binary color signal and the second binary color signal generated by the generation unit.

### BRIEF DESCRIPTION OF THE DRAWINGS

Exemplary embodiment(s) of the present invention will be described in detail based on the following figures, wherein:

FIG. 1 is a diagram showing a configuration example of a computer system to which the exemplary embodiment of the present invention is applied;

FIGS. 2A to 2C are diagrams for illustrating a first technique different from a technique according to the exemplary embodiment of the present invention;

FIGS. 3A to 3C are diagrams for illustrating a second technique different from the technique according to the exemplary embodiment of the present invention;

FIGS. 4A to 4C are diagrams for illustrating the technique according to the exemplary embodiment of the present invention;

FIG. 5 is a graph showing the difference of the effect between the first technique and the technique according to the exemplary embodiment of the present invention;

FIGS. 6A and 6B are diagrams showing a dither pattern for dark color signals and a dither pattern for light color signals used in the exemplary embodiment of the present invention, respectively;

FIG. 7 is a block diagram showing an example of the functional configuration of the screen processor according to the exemplary embodiment of the present invention;

FIG. 8 is a flowchart showing an operation example of the screen processor according to the exemplary embodiment of the present invention;

FIG. 9 is a diagram showing a configuration example of an image forming apparatus according to the exemplary embodiment of the present invention; and

FIG. 10 is a diagram showing an example of the hardware configuration of a computer capable of implementing the exemplary embodiment of the present invention.

### DETAILED DESCRIPTION

An exemplary embodiment of the present invention will be described below in detail with reference to the accompanying drawings.

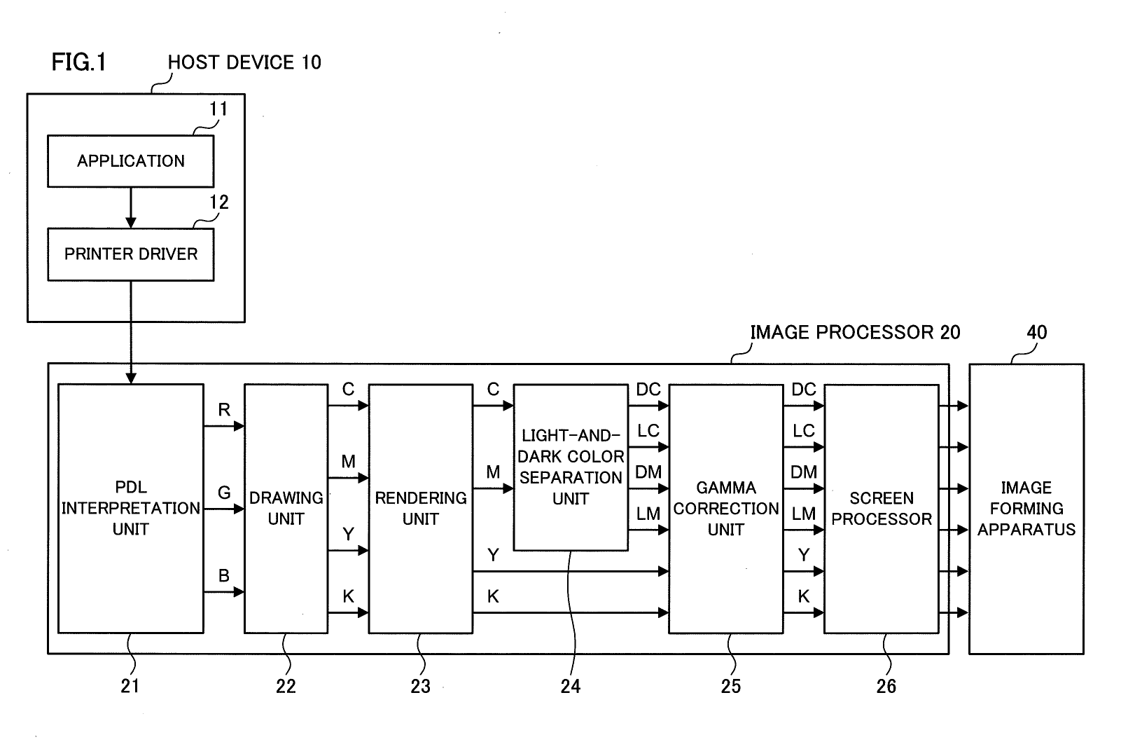

FIG. 1 is a diagram showing a configuration example of a computer system to which the exemplary embodiment of the present invention is applied.

As shown in FIG. 1, the computer system includes a host device 10, an image processor 20 and an image forming apparatus 40.

The host device 10 is a device to provide image data that is a source of an image to be formed on a recording medium such as paper. The host device 10 includes at least an application program (hereinafter, simply referred to as “application”) 11 and a printer driver 12. The host device 10 is implemented by a personal computer (PC), for example.

The application 11 is a document processing software, a spread sheet software or the like. The application 11 outputs to the printer driver 12 a command for requiring a print of data having been made.

The printer driver 12 receives the command, and converts the command into page description language (PDL), which is a drawing command for a printer.

The image processor 20 is a device that performs image processing to image data provided by the host device 10. The image processor 20 includes a PDL interpretation unit 21, a drawing unit 22, a rendering unit 23, a light-and-dark color separation unit 24, a gamma correction unit 25 and a screen processor 26. The image processor 20 is implemented inside of a printer, for example.

The PDL interpretation unit 21 interprets PDL when receiving the PDL from the host device 10.

The drawing unit 22 converts a color signal (RGB in FIG. 1) specified by the PDL into a color signal (CMYK in FIG. 1) of the image forming apparatus 40. On this occasion, the drawing unit 22 draws on the basis of intermediate codes in accordance with resolution of the image forming apparatus 40.

The rendering unit 23 performs rendering of the intermediate codes used for drawing by the drawing unit 22 into raster image data.

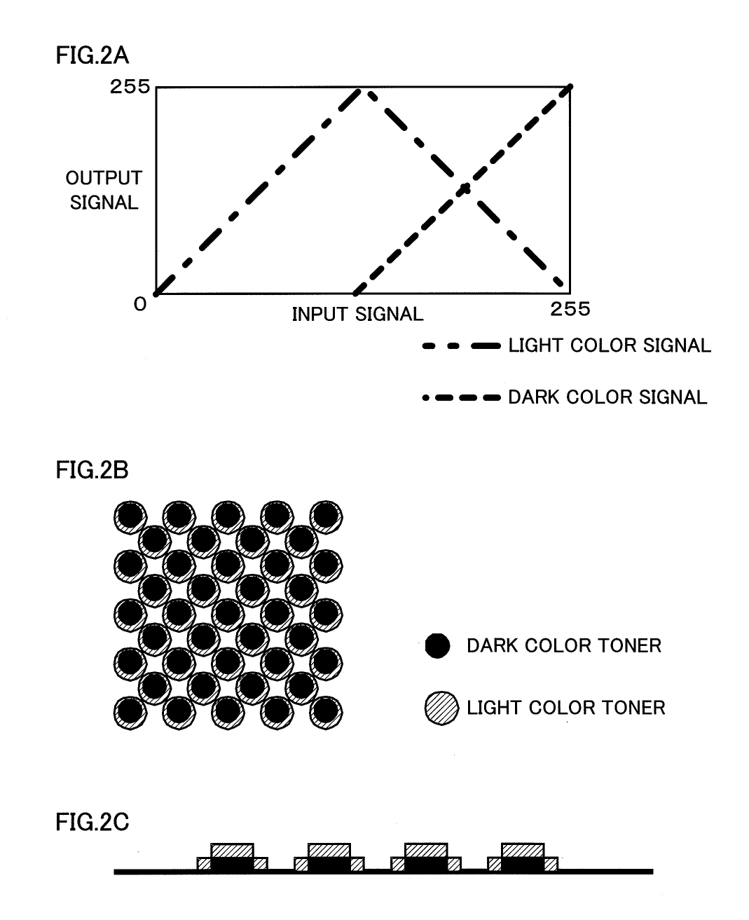

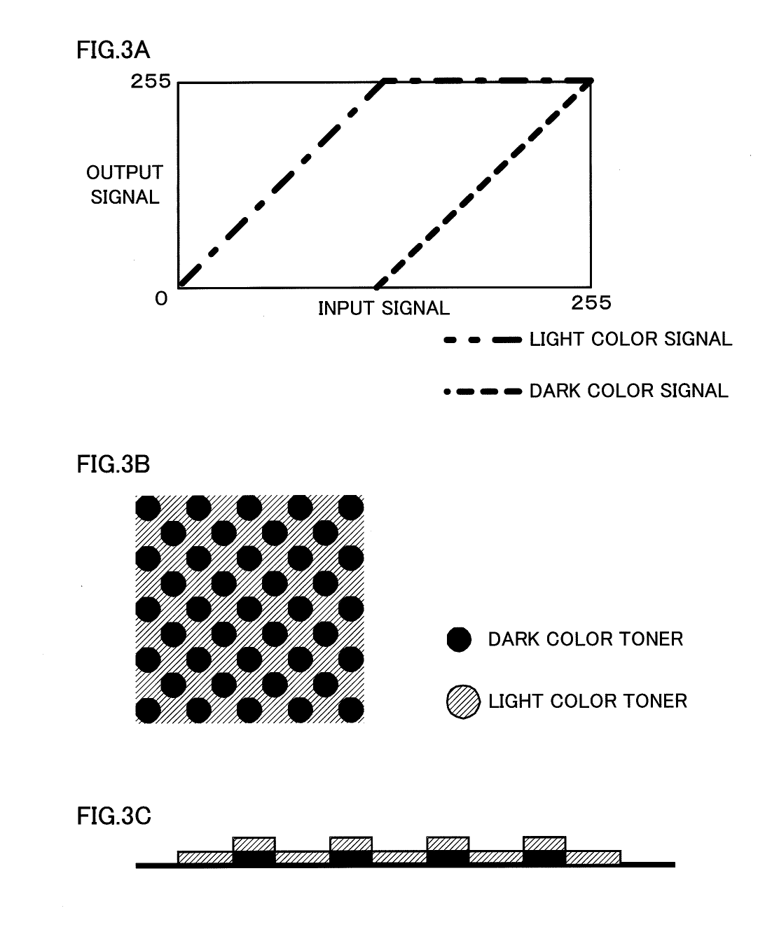

The light-and-dark color separation unit 24 separates a cyan (C) signal and a magenta (M) signal among CMYK signals into a dark color signal and a light color signal. Specifically, the light-and-dark color separation unit 24 separates the cyan (C) signal into a dark cyan (DC) signal and a light cyan (LC) signal, and separates the magenta (M) signal into a dark magenta (DM) signal and a light magenta (LM) signal. The separation is performed so that the separated signal is only a light color signal in a highlight region while being a combination of a light color signal and a dark color signal from a mid-tone region to a shadow region. For example, a LUT for light-and-dark color separation shown in FIG. 2A described later may be used for the separation. A LUT for light-and-dark color separation shown in FIG. 3A described later may also be used. In this case, however, a process to convert a color signal may be performed so that the use amount of toner does not exceed a predetermined limit value.

The gamma correction unit 25 performs the gamma correction for each color signal of DC, LC, DM, LM, Y and K.

The screen processor 26 performs screen processing (binarization processing), with a dither pattern, on color signals (multi-valued color signals) on which the gamma correction having been performed by the gamma correction unit 25. The screen processor 26 then outputs to the image forming apparatus 40 the color signal (binary color signal) subjected to the screen processing.

The image forming apparatus 40 is an apparatus that forms an image on a recording medium such as paper by use of toner corresponding to the color signals after the screen processing. In the present exemplary embodiment, the image forming apparatus 40 is provided as an example of a print mechanism or an image forming unit. The mechanism of the image forming apparatus 40 will be described later.

Incidentally, graininess is improved in a case where an image is formed by use of six colors or more of toners including toners of yellow and black and two kinds of light and dark toners for cyan and magenta, as compared to a case where an image is formed by use of four colors of toners of cyan, magenta, yellow and black.

However, when the screen processor 26 performs the screen processing, with the same dither pattern, on a dark color signal and a light color signal obtained by the light-and-dark color separation unit 24 separating a color signal, graininess is hardly improved in a shadow region (low brightness region) and a mid-tone region (intermediate region between a highlight region and a shadow region) in some cases, even though graininess is improved in a highlight region (high brightness region). The reason will be described below.

FIG. 2A is a diagram showing a look up table (LUT) for light-and-dark color separation used by the light-and-dark color separation unit 24 assumed herein.

As is clear from FIG. 3A, the use of this LUT for light-and-dark color separation gives the following color separation. As an input signal increases, only the light color signal increases in the highlight region, and then the dark color signal starts to increase around the mid-tone region, and then the light color signal decreases in the shadow region, which means that the use of the light color toner is restricted.

FIG. 2B is a diagram showing an arrangement example of halftone dots, formed in this case on a recording medium, from the mid-tone region to the shadow region, while FIG. 2C is a diagram showing a cross section of such halftone dots.

When the use of the light color toner from the mid-tone region to the shadow region is restricted as described above, dark color dots and light color dots are formed nearly the same positions from the mid-tone region to the shadow region as shown in FIG. 2B. In this case, the periodic brightness difference between halftone dot portions on which toners are put and white color portions on which no toner is put is visually perceived, which is regarded as poor graininess.

In order to deal with this problem, the following technique is also conceivable to improve the graininess in the shadow region and the mid-tone region.

FIG. 3A is a diagram showing a LUT for light-and-dark color separation used by the light-and-dark color separation unit 24 in this technique.

As is clear from FIG. 3A, the use of this LUT for light-and-dark color separation gives the following color separation. As an input signal increases, only the light color signal increases in the highlight region, and then the dark color signal starts to increase around the mid-tone region. However, in the shadow region, the light color signal does not decrease but keeps the maximum value.

FIG. 3B is a diagram showing an arrangement example of halftone dots, formed in this case on a recording medium, from the mid-tone region to the shadow region, while FIG. 3C is a diagram showing a cross section of such halftone dots.

The use of the LUT for light-and-dark color separation described above gives better graininess over the whole gradation. Specifically, with no restriction or less restriction on the use of the light color toner from the mid-tone region to the shadow region causes fewer white color portions to be generated, which makes the periodic brightness difference less perceptible and graininess improved. However, this technique has a problem that the toner consumption becomes higher.

Thus in the present exemplary embodiment, a dither pattern (hereinafter, referred to as “light color dither pattern”) used in the screen processing for a light color signal and a dither pattern (hereinafter, referred to as “dark color dither pattern”) used in the screen processing for a dark color signal are set to have the same angle and the same number of lines. Additionally, the center positions of halftone dots (light color halftone dots) formed by use of the light color dither pattern and those of halftone dots (dark color halftone dots) formed by use of the dark color dither pattern are set so as to be different from each other.

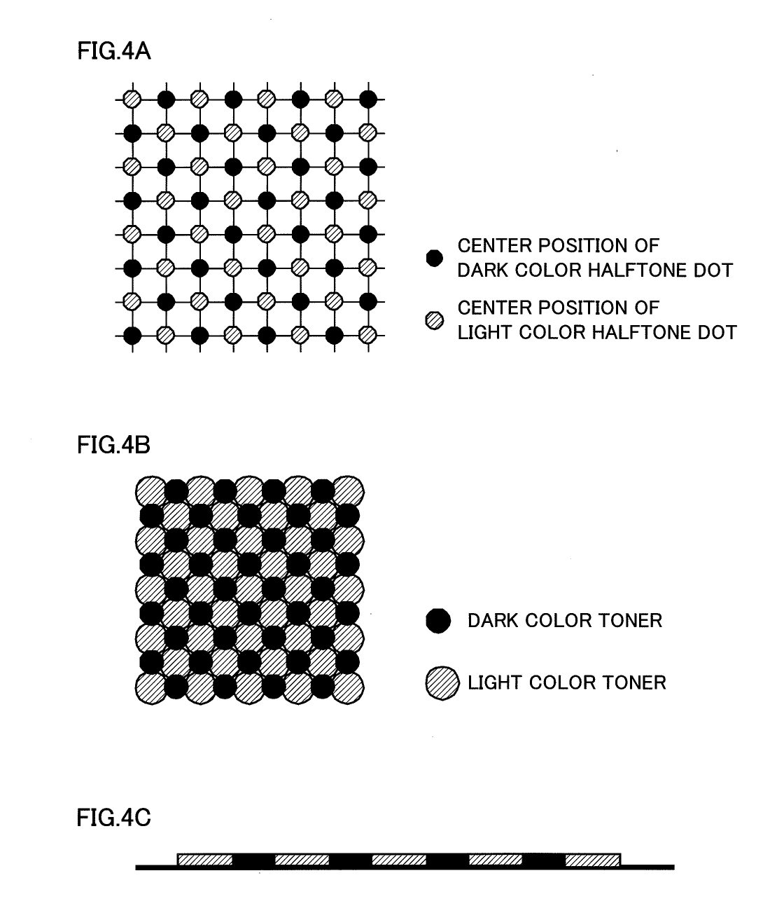

FIG. 4A is a diagram showing the relative positional relationship of this case between the centers of dark color halftone dots and those of light color halftone dots.

As shown in FIG. 4A, the centers of light color halftone dots are positioned on the left, right, top and bottom of those of dark color halftone dots. In the present exemplary embodiment, it is sufficient that the centers of light color halftone dots and those of dark color halftone dots do not coincide. However, as in the case of FIG. 4A, the center positions may be set so that the center of a light color halftone dot is positioned at the middle point of the centers of two dark color halftone dots, while the center of a dark color halftone dot is positioned at the middle point of the centers of two light color halftone dots, in an up-and-down direction and a left-and-right direction. Such a positional relationship may be taken that the center of a light color halftone dot is positioned at the barycenter of the centers of four dark color halftone dots, while the center of a dark color halftone dot is positioned at the barycenter of the centers of four light color halftone dots. It may also be taken that the center of a light color halftone dot is positioned at the intersection point of the diagonal lines of a quadrangle having the centers of four dark color halftone dots as vertices thereof, while the center of a dark color halftone dot is positioned at the intersection point of the diagonal lines of a quadrangle having the centers of four light color halftone dots as vertices thereof.

FIG. 4B is a diagram showing an arrangement example of halftone dots, formed in this case on a recording medium, from the mid-tone region to the shadow region, while FIG. 4C is a diagram showing a cross section of such halftone dots.

Setting the centers of light color halftone dots to lie on the left, right, top and bottom of those of dark color halftone dots as described above makes an overlapping area of these halftone dots be minimum. This forms a pattern in which the light color halftone dots cover the white color portions generated between the dark color halftone dots. Specifically, in the present exemplary embodiment, the area of the white color portions is made small, thereby to make the periodic brightness difference less perceptible and graininess improved. Additionally, in the present exemplary embodiment, graininess is improved over the whole gradation and the toner consumption is lowered, even with the LUT for light-and-dark color separation by which the use of light color toner from the mid-tone region to the shadow region is restricted as shown in FIG. 2A.

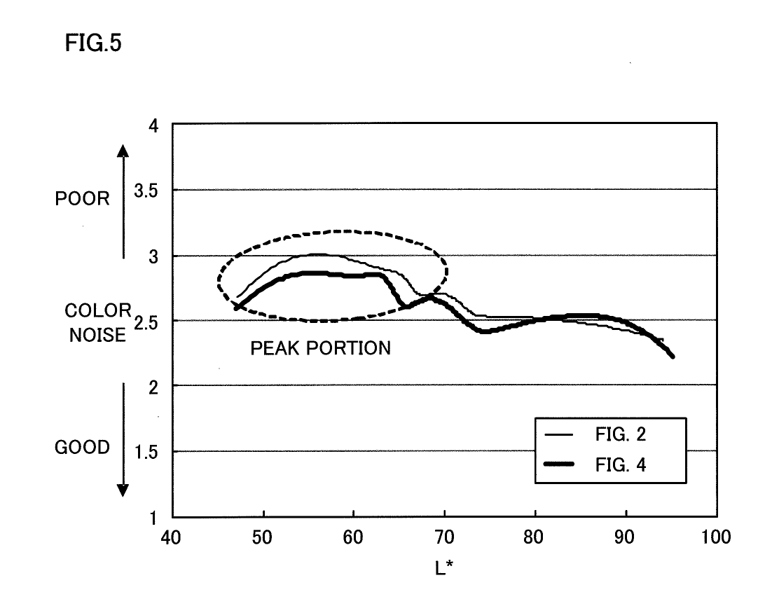

FIG. 5 is a graph showing the relationship between brightness L* and color noise that is an index indicating granularity, in a case where the LUT for light-and-dark color separation as is shown in FIG. 2A is used. This graph shows that the shift of the centers of light color halftone dots with respect to those of dark color halftone dots improves the granularity at the peak portion about 0.2 to 0.4.

Next, the screen processor 26 performing the screen processing as shown in FIGS. 4A to 4C will be described in detail.

A dither pattern used in the screen processor 26 will first be described.

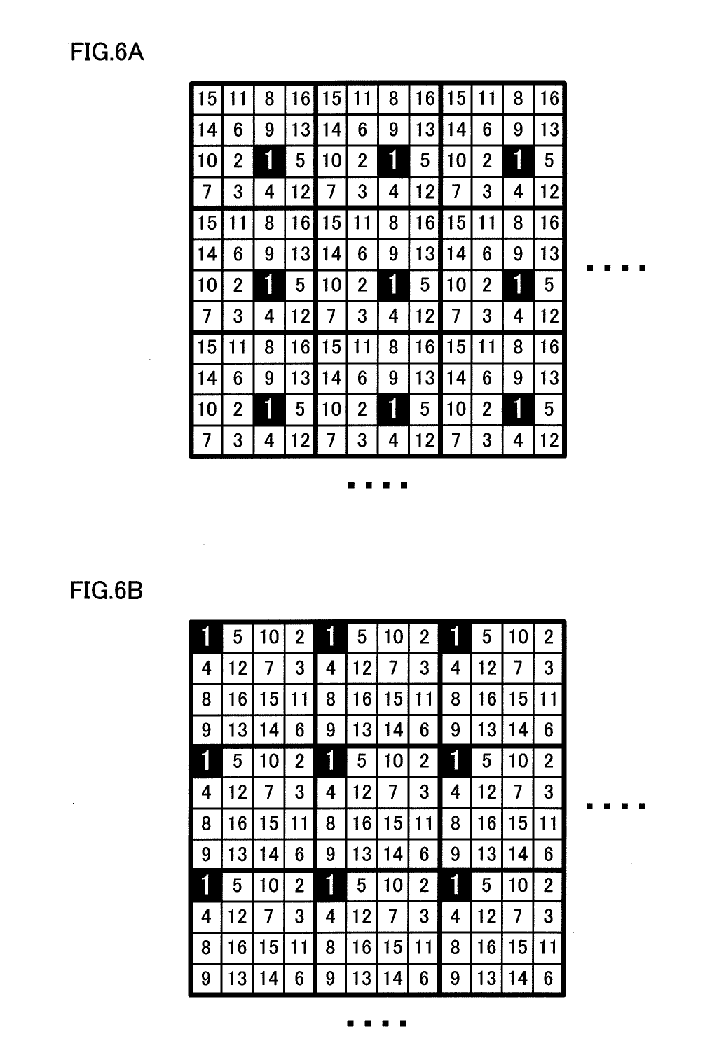

FIGS. 6A and 6B are diagrams showing specific examples of a dither pattern.

FIG. 6A is an example of the dark color dither pattern used for a DC color signal, for example, while FIG. 6B is an example of the light color dither pattern used for a LC color signal, for example.

These dither patterns are formed by periodically repeating the respective fundamental cells enclosed with a bold line. Each of the fundamental cells contain threshold values of four rows times four columns at the positions corresponding to pixels of four rows times four columns, which values are compared with the pixel values when the multi-valued pixel value of each pixel is binarized. However, the positions at which the same threshold values are contained are shifted by a half of the fundamental cell (half phase) in the up-and-down and left-and-right directions, between the dark color dither pattern of FIG. 6A and the light color dither pattern of FIG. 6B. For example, the threshold value “1” (reverse display in FIGS. 6A and 6B) corresponding to the center of a halftone dot is positioned on the third row from the top and on the third column from the left of the fundamental cell in FIG. 6A, while positioned on the first row from the top and on the first column from the left of the fundamental cell in FIG. 6B.

Note that these dither patterns are only examples. Threshold values may be contained in an arbitrary order as long as there is difference between the positions of the dark color halftone dots (particularly the center positions thereof) formed by the dark color dither pattern of FIG. 6A and those of the light color halftone dots (particularly the center positions thereof) formed by the light color dither pattern of FIG. 6B. For example, for a fundamental cell of M rows times N columns, the order may be such that only the minimum threshold value “1” is shifted by (M/2) in the row direction and by (N/2) in the column direction, while the other threshold values are contained at positions freely determined. Instead, the order may be such that all the threshold values are shifted by (M/2) in the row direction and by (N/2) in the column direction as shown in FIGS. 6A and 6B. Here, the row direction is an example of one direction, while the column direction is an example of the other direction.

Next, a description will be given of a functional configuration of the screen processor 26.

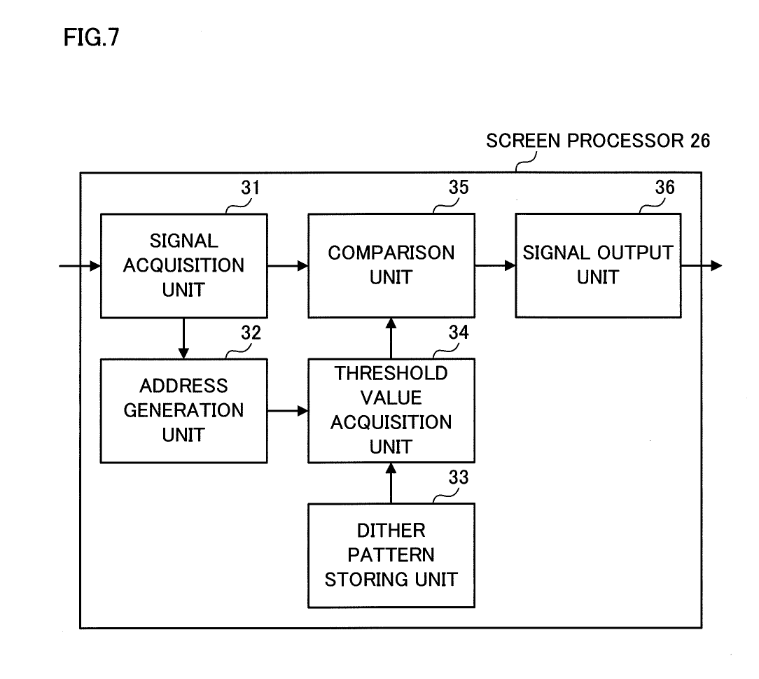

FIG. 7 is a block diagram showing an example of the functional configuration of the screen processor 26.

As shown in FIG. 7, the screen processor 26 includes a signal acquisition unit 31, an address generation unit 32, a dither pattern storing unit 33, a threshold value acquisition unit 34, a comparison unit 35 and a signal output unit 36.

The signal acquisition unit 31 acquires color signals of DC, LC, DM, LM, Y and K on each of which the gamma correction is performed by the gamma correction unit 25. In the present exemplary embodiment, a DC color signal or a DM color signal is used as an example of a first multi-valued color signal, while a LC color signal or a LM color signal is used as an example of a second multi-valued color signal. The signal acquisition unit 31 is provided as an example of an acquisition unit that acquires the first multi-valued color signal and the second multi-valued color signal.

The address generation unit 32 generates an address signal that indicates a position corresponding to a pixel, in the fundamental cell of the dither pattern, on the basis of the position of the pixel corresponding to the color signal acquired by the signal acquisition unit 31 and the angle and the number of lines defined for each type (C, M, Y, K) of color signals.

The dither pattern storing unit 33 stores dither patterns for color signals of DC, LC, DM, LM, Y and K. Among these, although the dither pattern for the DC color signal and the dither pattern for the LC color signal have the same angle and the same number of lines, the threshold values thereof are supposed to be set so that the center positions of halftone dots formed by use of the former dither pattern and those of halftone dots formed by use of the latter dither pattern are different from each other. Additionally, although the dither pattern for the DM color signal and the dither pattern for the LM color signal have the same angle and the same number of lines, the threshold values thereof are supposed to be set so that the center positions of halftone dots formed by use of the former dither pattern and those of halftone dots formed by use of the latter dither pattern are different from each other. Although dither patterns formed by periodically repeating fundamental cells are shown in FIGS. 6A and 6B, the dither pattern storing unit 33 is supposed to store the threshold values in one fundamental cell.

The threshold value acquisition unit 34 reads out, among the dither patterns stored in the dither pattern storing unit 33, the fundamental cell of a dither pattern corresponding to a type (DC, LC, DM, LM, Y or K) of the color signal acquired by the signal acquisition unit 31. The threshold value acquisition unit 34 then acquires the threshold value of the position in the fundamental cell indicated by the address signal received from the address generation unit 32.

The comparison unit 35 compares the value of the color signal acquired by the signal acquisition unit 31 with the threshold value acquired by the threshold value acquisition unit 34, and outputs the result of comparison as a binary color signal. In the present exemplary embodiment, the comparison unit 35 is provided as an example of a generation unit that generates a first binary color signal and a second binary color signal.

The signal output unit 36 outputs to the image forming apparatus 40 the binary color signal outputted by the comparison unit 35. In the present exemplary embodiment, the signal output unit 36 is provided as an example of an output unit that outputs to a print mechanism the first binary color signal and the second binary color signal.

Next, an operation of the screen processor 26 will be described.

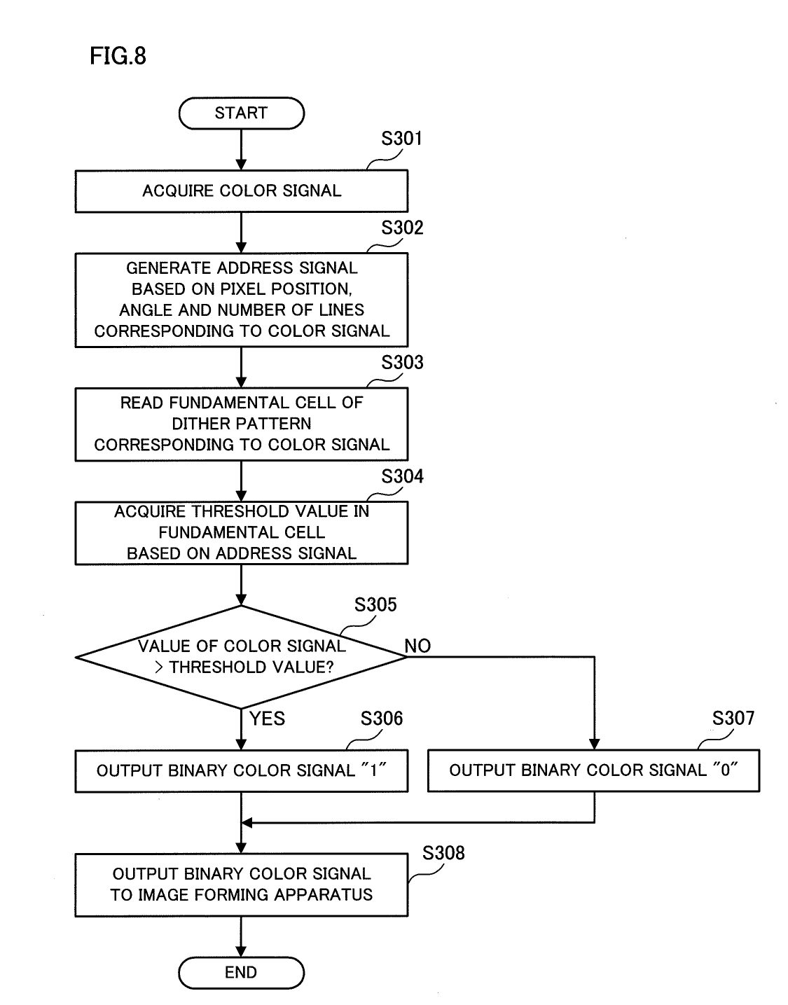

FIG. 8 is a flowchart showing an operation example of the screen processor 26.

In the screen processor 26, the signal acquisition unit 31 first acquires a color signal from the gamma correction unit 25 (Step 301).

The address generation unit 32 then generates an address signal indicating a position in the fundamental cell, on the basis of the position of the pixel corresponding to the color signal acquired by the signal acquisition unit 31 and the angle and the number of lines defined for a type of the color signal (Step 302).

Furthermore, the threshold value acquisition unit 34 reads, among the fundamental cells of the dither patterns stored in the dither pattern storing unit 33, the fundamental cell corresponding to the type of the color signal acquired by the signal acquisition unit 31 (Step 303). The threshold value acquisition unit 34 then acquires the threshold value contained at the position in the fundamental cell indicated by the address signal generated by the address generation unit 32 (Step 304).

Thereafter, the comparison unit 35 compares the value of the color signal acquired by the signal acquisition unit 31 with the threshold value acquired by the threshold value acquisition unit 34, and determines which value is larger (Step 305). If the value of the color signal acquired by the signal acquisition unit 31 is determined to be larger, the comparison unit 35 outputs “1” as a binary color signal (Step 306). If the threshold value acquired by the threshold value acquisition unit 34 is determined to be larger, the comparison unit 35 outputs “0” as the binary color signal (Step 307).

Then, the signal output unit 36 finally outputs to the image forming apparatus 40 the binary color signal outputted in Step 306 or Step 307 (Step 308).

Here, a description will be given of the image forming apparatus 40.

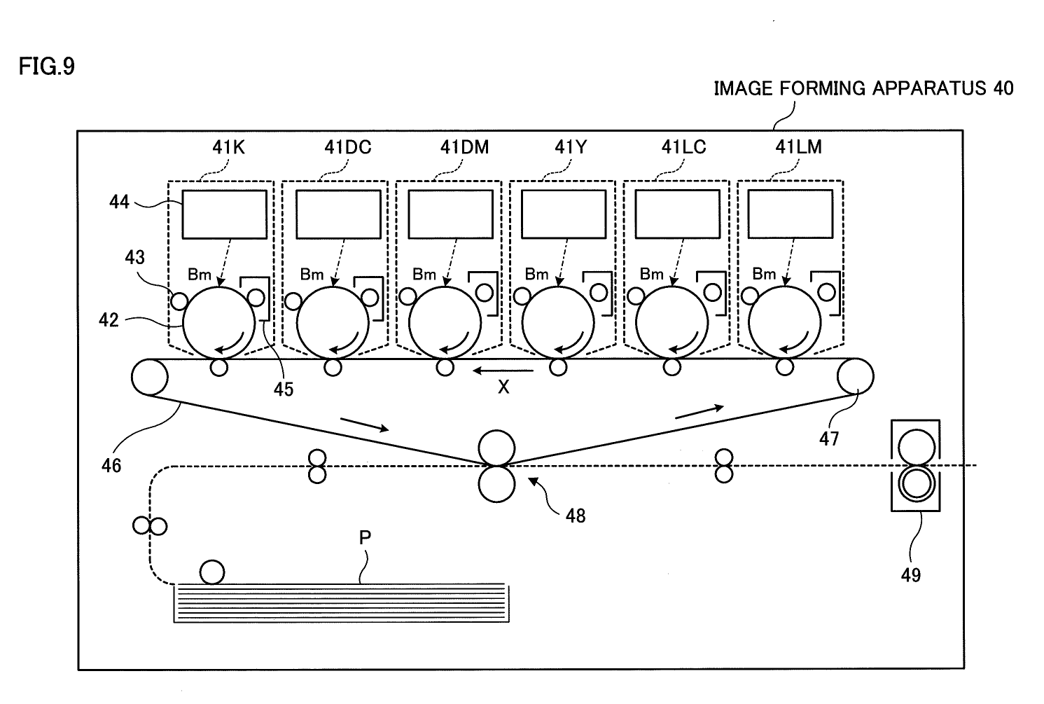

FIG. 9 is a diagram showing a configuration example of the image forming apparatus 40.

The image forming apparatus 40 includes six image forming units 41LM, 41LC, 41Y, 41DM, 41DC and 41K that form toner images of light magenta (LM), light cyan (LC), yellow (Y), dark magenta (DM), dark cyan (DC) and black (K), respectively. Each of the image forming units 41 includes: a photoconductive drum 42 that has a photoconductive layer; a charging device 43 that charges the surface of the photoconductive drum 42; an exposure device 44 that exposes the photoconductive drum 42 to form an electrostatic latent image on the photoconductive drum 42; and a developing device 45 that develops the electrostatic latent image on the photoconductive drum 42 to form a toner image.

The image forming apparatus 40 also includes: an intermediate transfer belt 46 that transports the toner images formed by the image forming units 41 toward a sheet P; a belt driving unit 47 that drives the intermediate transfer belt 46; a transfer roll 48 that transfers, onto the sheet P, the toner image on the intermediate transfer belt 46; and a fixing device 49 that fixes, onto the sheet P with pressure and heat, the toner image transferred on the sheet P.

Next, an image forming process in the image forming apparatus 40 will be described. This image forming process starts when the screen processor 26 of the image processor 20 outputs a binary color signal to the exposure device 44.

The exposure device 44 emits a laser beam, for example, according to a color signal for each color component, hereby to expose the photoconductive drum 42 in the image forming unit 41. On this occasion, for example, in the image forming unit 41K that forms a toner image of K (black) color, the photoconductive drum 42 charged by the charging device 43 is exposed by the exposure device 44, and thereby an electrostatic latent image of K color is formed on the photoconductive drum 42. The electrostatic latent image of K color formed on the photoconductive drum 42 is developed by the developing device 45, and thereby a toner image of K color is formed on the photoconductive drum 42. Similarly, toner images of LM, LC, Y, DM and DC colors are formed in the image forming units 41LM, 41LC, 41Y, 41DM and 41DC, respectively.

The color toner images formed respectively on the photoconductive drums 42 of the image forming units 41 are electrostatically transferred (primarily transferred), one by one, on the intermediate transfer belt 46 moving in the direction of an arrow X, and thereby the superposed toner images on which the color toner images are superposed are formed. The superposed toner images on the intermediate transfer belt 46 are transported to the region at which the transfer roll 48 is arranged, along with the movement of the intermediate transfer belt 46. The superposed toner images are then collectively and electrostatically transferred (secondarily transferred) by the transfer roll 48 onto the sheet P having been transported. Note that in the present exemplary embodiment, the centers of halftone dots of a DC toner image and those of halftone dots of a LC toner image are shifted so as to be different from each other in the superposed toner images. The centers of halftone dots of a DM toner image and those of halftone dots of a LM toner image are also shifted so as to be different from each other.

Thereafter, the sheet P on which the superposed toner images are electrostatically transferred is transported to the fixing device 49. The superposed toner images are then fixed onto the sheet P.

The description of the present exemplary embodiment is now finished.

In the present exemplary embodiment, the description has been given in the case where the dither pattern storing unit 33 stores the threshold values in a fundamental cell of a dither pattern. However, the dither pattern storing unit 33 may store the threshold values of the whole dither pattern formed by periodically repeating the fundamental cells as shown in FIGS. 6A and 6B.

The image processor 20 according to the present exemplary embodiments may be implemented not only in a printer but also in a generally used computer, such as a PC.

Referring to such a generally used computer as a computer 90, a hardware configuration thereof will be described hereinafter.

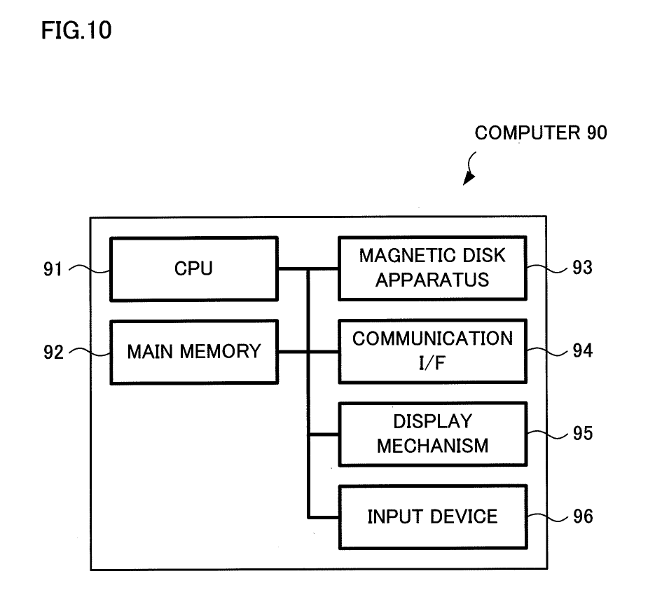

FIG. 10 is a diagram illustrating the hardware configuration of the computer 90.

As shown in FIG. 10, the computer 90 includes a central processing unit (CPU) 91, a main memory 92 and a magnetic disk apparatus (HDD: Hard Disk Drive) 93. Here, the CPU 91 executes operation system (OS) and various kinds of software such as application, and realizes various functions as described above. The main memory 92 is a memory area that stores various kinds of software, data used for executing the software and the like. The magnetic disk apparatus 93 is a memory area that stores input data to various kinds of software, output data from various kinds of software and the like.

Further, the computer 90 includes a communication I/F 94 that performs communication with external devices, a display mechanism 95 including a video memory, a display and the like, and an input device 96 such as a keyboard, a mouse or the like.

The program that achieves the present exemplary embodiments may be provided not only by a communication unit but also by being stored in a recording medium such as a CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A color processor comprising:
an acquisition unit that acquires a first multi-valued color signal indicating in a multi-valued manner a quantity of a first color material used for reproducing color with a specific hue, and that acquires a second multi-valued color signal indicating in a multi-valued manner a quantity of a second color material used for reproducing color with the specific hue, the second color material having a different density from the first color material;
a generation unit that generates a first binary color signal by performing dither processing, with a first dither matrix, for the first multi-valued color signal acquired by the acquisition unit, and that generates a second binary color signal by performing dither processing, with a second dither matrix, for the second multi-valued color signal acquired by the acquisition unit, the second dither matrix having the same angle and the same number of lines as the first dither matrix and being used for forming halftone dots at positions different from positions of halftone dots formed by use of the first dither matrix; and
an output unit that outputs to a print mechanism the first binary color signal and the second binary color signal generated by the generation unit.

2. The color processor according to claim 1, wherein the generation unit generates the second binary color signal by performing the dither processing, with the second dither matrix, for the second multi-valued color signal acquired by the acquisition unit, the second dither matrix having the same angle and the same number of lines as the first dither matrix and being used for forming halftone dots so that each of the halftone dots is at a position of a barycenter of four halftone dots formed by use of the first dither matrix.

3. The color processor according to claim 1, wherein
the first dither matrix and the second dither matrix are formed of a first fundamental matrix and a second fundamental matrix, respectively, that each contain M threshold values in one direction and N threshold values in the other direction, where M and N are natural numbers, and
a position in the second fundamental matrix at which a minimum threshold value is contained is shifted by (M/2) in the one direction and by (N/2) in the other direction from a position in the first fundamental matrix at which a minimum threshold value is contained.

4. The color processor according to claim 1, wherein
the first dither matrix and the second dither matrix are formed of a first fundamental matrix and a second fundamental matrix, respectively, that each contain M threshold values in one direction and N threshold values in the other direction, where M and N are natural numbers, and
the second dither matrix is a matrix obtained by shifting the threshold values of the first fundamental matrix by (M/2) in the one direction and by (N/2) in the other direction.

5. An image forming apparatus comprising:
an acquisition unit that acquires a first multi-valued color signal indicating in a multi-valued manner a quantity of a first color material used for reproducing color with a specific hue, and that acquires a second multi-valued color signal indicating in a multi-valued manner a quantity of a second color material used for reproducing color with the specific hue, the second color material having a different density from the first color material;
a generation unit that generates a first binary color signal by performing dither processing, with a first dither matrix, for the first multi-valued color signal acquired by the acquisition unit, and that generates a second binary color signal by performing dither processing, with a second dither matrix, for the second multi-valued color signal acquired by the acquisition unit, the second dither matrix having the same angle and the same number of lines as the first dither matrix and being different from the first dither matrix; and
an image forming unit that forms an image of first halftone dots on a recording medium with the first color material on the basis of the first binary color signal generated by the generation unit, and that forms an image of second halftone dots on the recording medium with the second color material on the basis of the second binary color signal generated by the generation unit so that positions of the second halftone dots are different from positions of the first halftone dots.

6. The image forming apparatus according to claim 5, wherein the image forming unit forms the image of the second halftone dots on the recording medium with the second color material on the basis of the second binary color signal generated by the generation unit so that a position of each of the second halftone dots is a position of a barycenter of four of the first halftone dots.

7. A color processing method comprising:
acquiring a first multi-valued color signal indicating in a multi-valued manner a quantity of a first color material used for reproducing color with a specific hue, and a second multi-valued color signal indicating in a multi-valued manner a quantity of a second color material used for reproducing color with the specific hue, the second color material having a different density from the first color material;
generating a first binary color signal by performing dither processing, with a first dither matrix, for the first multi-valued color signal, and a second binary color signal by performing dither processing, with a second dither matrix, for the second multi-valued color signal, the second dither matrix having the same angle and the same number of lines as the first dither matrix and being used for forming halftone dots at positions different from positions of halftone dots formed by use of the first dither matrix; and
outputting to a print mechanism the first binary color signal and the second binary color signal.

8. A computer readable medium storing a program that causes a computer to execute a process for color processing, the process comprising:
acquiring a first multi-valued color signal indicating in a multi-valued manner a quantity of a first color material used for reproducing color with a specific hue, and a second multi-valued color signal indicating in a multi-valued manner a quantity of a second color material used for reproducing color with the specific hue, the second color material having a different density from the first color material;
generating a first binary color signal by performing dither processing, with a first dither matrix, for the first multi-valued color signal, and a second binary color signal by performing dither processing, with a second dither matrix, for the second multi-valued color signal, the second dither matrix having the same angle and the same number of lines as the first dither matrix and being used for forming halftone dots at positions different from positions of halftone dots formed by use of the first dither matrix; and
outputting to a print mechanism the first binary color signal and the second binary color signal.

9. A computer readable medium storing:
an image of first halftone dots that are formed so as to have a specific distance in a specific direction in a specific region, by use of a first color material used for reproducing color with a specific hue; and
an image of second halftone dots that are formed so as to have the specific distance in the specific direction in the specific region, by use of a second color material used for reproducing color with the specific hue, and that are formed at positions where the center of each of the second halftone dots does not coincide with the center of each of the first halftone dots, the second color material having a different density from the first color material.
